(19) United States
(12) Patent Application Publication
(10) Pub. No.: US 2023/0259761 A1
(43) Pub. Date: Aug. 17, 2023

(54) TRANSFER LEARNING SYSTEM AND METHOD FOR DEEP NEURAL NETWORK

(71) Applicant: ELECTRONICS AND TELECOMMUNICATIONS RESEARCH INSTITUTE, Daejeon (KR)

(72) Inventors: Yong Jin LEE, Daejeon (KR); Mal Hee KIM, Daejeon (KR)

(21) Appl. No.: 17/938,650

(22) Filed: Oct. 6, 2022

(30) Foreign Application Priority Data
Feb. 15, 2022 (KR) 10-2022-0019646

(51) Int. Cl. G06N 3/08; G06N 3/04

(52) U.S. Cl. CPC G06N 3/08; G06N 3/0454

(57) ABSTRACT

Disclosed is a transfer learning system for a deep neural network. The transfer learning system includes a pre-trained model storage unit configured to store a plurality of pre-trained models that are deep neural network models learned using one or more pre-training datasets, a transfer learning data input unit configured to receive transfer learning data, a pre-trained model selecting unit configured to select a pre-trained model corresponding to the transfer learning data from among the plurality of stored pre-trained models, and a transfer learning unit configured to generate one or more transfer learning models by performing transfer learning using the selected pre-trained model and the transfer learning data.

### CROSS-REFERENCE TO RELATED APPLICATIONS

This application claims the benefit of the Korean Patent Application No. 10-2022-0019646 filed on Feb. 15, 2022, which is hereby incorporated by reference as if fully set forth herein.

### BACKGROUND

### Field of the Invention

The present invention relates to a transfer learning system and method, and more particularly, to a system and method for finding an optimal learning model for transfer learning.

### Discussion of the Related Art

In order for a deep neural network to have a high recognition rate or prediction accuracy, it needs a lot of data for training. If the training data is insufficient, the deep neural network may not be able to exhibit an appropriate recognition rate or accuracy. Therefore, when training data is insufficient, transfer learning is used in which a previously learned model is reused using a large amount of data in a similar domain.

However, it is not easy to determine domain similarity by analyzing characteristics of several large-scale datasets and it takes a lot of time. Also, there is no guarantee that an optimal similar domain may be found. In addition, there may be no similar datasets among retained data. Also, even if the same training data is used, the recognition rate and accuracy may vary according to deep neural network models. An appropriate deep neural network model should be selected according to training data, which also requires expertise in the deep neural network model, and requires a lot of time and effort.

Therefore, when there are various selectable pre-training data and various deep neural network models, there is a need for a method to automatically search an optimal pre-trained model configuration to increase the effect of transfer learning.

### SUMMARY

An aspect of the present invention is directed to providing a transfer learning system and method for preparing various pre-training datasets and a pre-trained model learned using the same and automatically searching an optimal pre-trained model for transfer learning so that appropriate transfer learning may be provided.

To achieve these and other advantages and in accordance with the purpose of the invention, as embodied and broadly described herein, there is provided a transfer learning system for a deep neural network including: a pre-trained model storage unit configured to store a plurality of pre-trained models that are deep neural network models learned using one or more pre-training datasets; a transfer learning data input unit configured to receive transfer learning data; a pre-trained model selecting unit configured to select a pre-trained model corresponding to the transfer learning data from among the plurality of stored pre-trained models; and a transfer learning unit configured to generate one or more transfer learning models by performing transfer learning using the selected pre-trained model and the transfer learning data.

The pre-trained model selecting unit may derive a feature of the transfer learning data from an output of a first part or a second part of the plurality of stored pre-trained models and select a pre-trained model based on clustering for the transfer leaning data using the feature of the transfer learning data.

The transfer learning system may further include a user requirement input unit for inputting a user requirement, wherein the pre-trained model selecting unit may select a pre-trained model corresponding to the input user requirement or the input transfer learning data.

The pre-trained model selecting unit may derive a feature of the transfer learning data based on an output of a first part or a second part of the pre-trained model corresponding to the user requirement and select a pre-trained model based on clustering for the transfer leaning data using the feature of the transfer learning data.

The pre-trained model selecting unit may perform performance evaluation on a result of performing clustering and select the pre-trained model in the order of the highest performance evaluation score. Alternatively, the pre-trained model selecting unit may calculate a performance evaluation score based on normalized mutual information (NMI) derived for the result of performing the clustering.

The transfer learning system may further include: a transfer learning model output unit configured to calculate classification performance accuracy for the plurality of generated transfer learning models and select and output one or more transfer learning models in the order of the highest classification performance accuracy.

The transfer learning model output unit may first select a first transfer learning model having the highest classification performance accuracy, and select a second transfer learning model having the greatest accuracy improvement when configuring an ensemble with the first transfer learning model, to configure the ensemble, and may configure the ensemble by adding a transfer learning mode having the highest accuracy improvement, when added to a previously configured ensemble, as an ensemble member.

In another aspect of the present invention, there is provided a transfer learning method for a deep neural network including: a pre-trained model storing step of storing a plurality of pre-trained models that are deep neural network models learned using a plurality of pre-training datasets; a transfer learning data input step of inputting transfer learning data; a pre-trained model selecting step of selecting a pre-trained model corresponding to the input transfer learning data from among the plurality of stored pre-trained models; and a transfer learning step of generating a plurality of transfer learning models by performing transfer learning using the selected pre-trained model and the transfer learning data.

The pre-trained model selecting step may include: generating an output of a first part or a second part of the plurality of stored pre-trained models as a feature of the transfer learning data; and selecting a pre-trained model by performing clustering on the transfer learning data by using the feature of the transfer learning data.

In another aspect of the present invention, there is provided a transfer learning method for a deep neural network including: a pre-trained model selecting step of selecting a pre-trained model corresponding to transfer learning data from among a plurality of stored pre-trained models; a transfer learning step of generating a plurality of transfer learning models by performing transfer learning using the selected pre-trained model and the transfer learning data; and a step of configuring an ensemble by selecting at least some of the plurality of transfer learning models.

The step of configuring the ensemble may include: configuring an ensemble by adding a transfer learning model having the highest accuracy among the plurality of transfer learning models and a transfer learning model that contributes the most to improvement of accuracy of the transfer learning model; and sequentially adding a transfer learning model that contributes the most to the improvement of the accuracy of the pre-configured ensemble to the ensemble until a preset accuracy is satisfied.

According to an aspect of the present invention, it is possible to learn a deep neural network at an appropriate level or higher even with a small amount of data by automatically searching an optimal pre-trained model for transfer learning.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a diagram schematically illustrating a configuration of a transfer learning system for a deep neural network according to an embodiment of the present invention.

FIG. 2 is a diagram illustrating an example of a configuration of a deep neural network used in a transfer learning system for a deep neural network according to an embodiment of the present invention.

FIG. 3 is a diagram illustrating a process of selecting a pre-trained model in a pre-trained model selecting unit of a transfer learning system for a deep neural network according to an embodiment of the present invention.

FIG. 4 is an example illustrating a process of evaluating clustering in a pre-trained model selecting unit of a transfer learning system for a deep neural network according to an embodiment of the present invention.

FIG. 5 is a flowchart illustrating a transfer learning method for a deep neural network according to an embodiment of the present invention.

FIG. 6 is a block diagram illustrating a computer system for implementing a transfer learning method for a deep neural network according to an embodiment of the present invention.

### DETAILED DESCRIPTION OF THE INVENTION

Hereinafter, exemplary embodiments of the present invention will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to one of ordinary skill in the art. In the drawings, the dimensions of layers and regions are exaggerated or reduced for clarity of illustration. For example, a dimension and thickness of each element in the drawings are arbitrarily illustrated for clarity, and thus, embodiments of the present invention are not limited thereto.

In this disclosure below, when it is described that one comprises (or includes or has) some elements, it should be understood that it may comprise (or include or has) only those elements, or it may comprise (or include or have) other elements as well as those elements if there is no specific limitation.

Moreover, each of terms such as “ . . . unit”, “ . . . apparatus” and “module” described in specification denotes an element for performing at least one function or operation, and may be implemented in hardware, software or the combination of hardware and software.

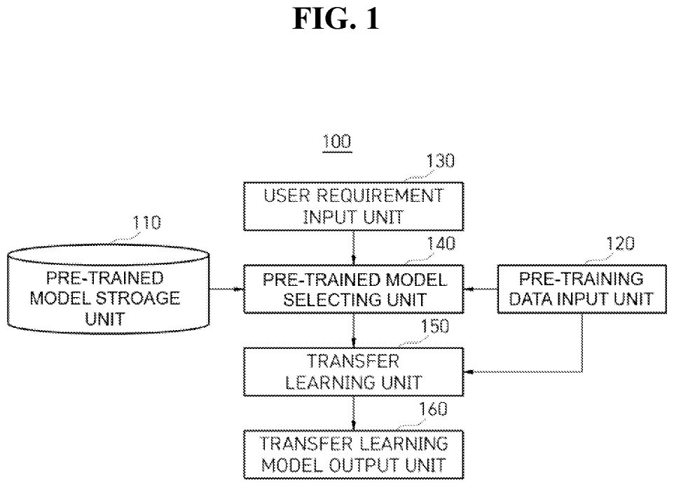

FIG. 1 is a diagram schematically illustrating a configuration of a transfer learning system for a deep neural network according to an embodiment of the present invention.

Referring to FIG. 1, a transfer learning system 100 for a deep neural network according to an embodiment of the present invention includes a pre-trained model storage unit 110, a transfer learning data input unit 120, a user requirement input unit 130, a pre-trained model selecting unit 140, a transfer learning unit 150, and a transfer learning model output unit 160. The transfer learning system 100 for a deep neural network shown in FIG. 1 is according to an embodiment, and the components shown in FIG. 1 are not limited to the embodiment shown in FIG. 1 and may be added, changed, or deleted.

In the transfer learning system 100 for a deep neural network according to an embodiment of the present invention, training data is divided into pre-training data and transfer learning data and described.

In an embodiment of the present invention, the pre-training data refers to a sufficient amount of data (e.g., 10,000 or more datasets) for training of a deep neural network for several domains. Transfer learning data is less than pre-training data and includes data limited to a specific domain. The pre-trained model refers to a deep neural network model learned in advance before transfer learning using pre-training data. The transfer learning model refers to a model learned using transfer learning data and a pre-trained model.

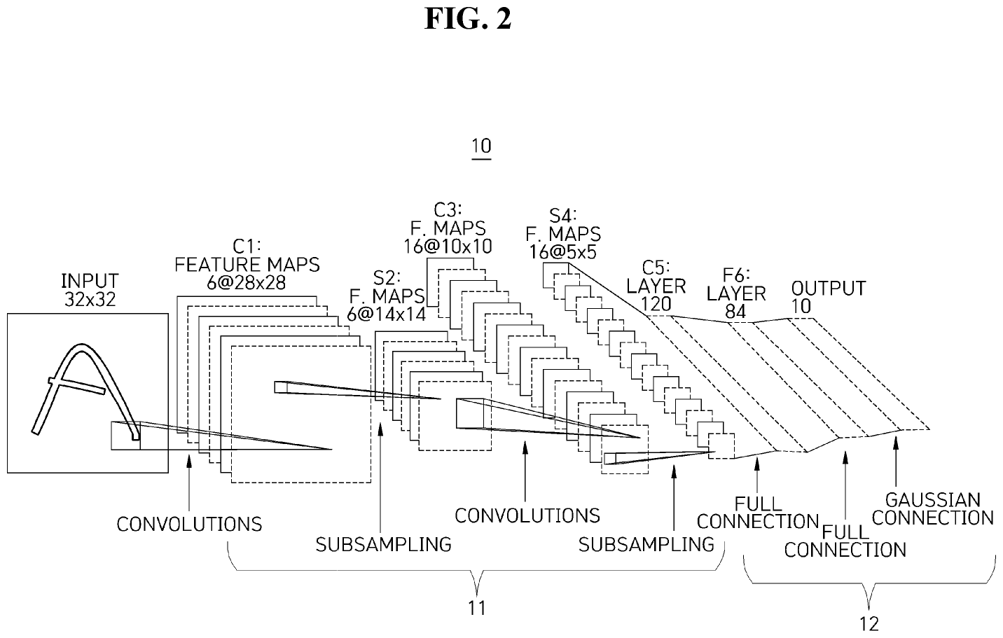

Before describing in detail the transfer learning system 100 for a deep neural network according to an embodiment of the present invention, a deep neural network used in an embodiment of the present invention will be described with reference to FIG. 2 below.

FIG. 2 is a diagram illustrating an example of a configuration of a deep neural network used in a transfer learning system for a deep neural network according to an embodiment of the present invention.

In FIG. 2, an example of a convolutional neural network (CNN) 10, which is one of the most utilized models in a deep neural network, is illustrated. In consideration of the versatility and scalability of the CNN 10, the embodiment will be mainly described based on the CNN but the deep neural network of the present invention is not limited to the CNN.

The CNN 10 includes a first part 11 including convolutions and pooling operations and a second part 12 including a fully connected layer or dense layer in which all nodes of a previous layer are connected to all nodes of a next layer.

In general, it is known that the first part 11 of most deep neural networks including CNN mainly plays a role of a feature extractor, and the second part 12 mainly plays a role of a classifier. An output of the first part 11 is an input of the second part 12.

It is known that main abstract information is gradually extracted by refining the input data from an input layer of the first part 11, passing through a last layer, to an output layer of the second part 12.

Referring back to FIG. 1, a detailed configuration of the transfer learning system 100 for a deep neural network according to an embodiment of the present invention will be described.

The pre-trained model storage unit 110 stores a plurality of deep neural network models learned using a pre-training dataset of one or more domains, that is, a plurality of pre-trained models.

In an embodiment, the pre-trained model storage unit 110 may pre-learn a pre-trained model generated by training multiple deep neural networks with one dataset. For example, the pre-trained model storage unit 110 may learn different types of models, such as ResNet or DenseNet, for the same data set. Alternatively, the pre-trained model storage unit 110 may learn a plurality of ResNets each having 10, 20, or 30 layers for the same data.

As another embodiment, a plurality of pre-trained models may be generated by applying several different datasets of the same or heterogeneous domains to one deep neural network.

The pre-trained model storage unit 110 may store characteristics of the pre-trained model together. For example, the pre-trained model storage unit 110 may store a size of the pre-trained model (a file size or the number of parameters) or the amount of calculation (FLOPs, Multi-Adds) of the pre-trained model. In addition, the characteristics of the pre-training data may be stored together. In the case of an image-based classification problem, whether it is to classify the type of car or the type of flower may be specified. Alternatively, whether it is to classify a general image such as ImageNet (ILSVRC2012) data in the pre-trained model storage unit 110 may be specified.

In addition, the pre-trained model storage unit 110 may specify the pre-trained model and classification performance according to the pre-training data. For example, classification performance may be specified as Top-1 accuracy or a confusion matrix.

The transfer learning data input unit 120 receives transfer learning data and transmits the transfer learning data to the pre-trained model selecting unit 140 and the transfer learning unit 150. The transfer learning data input unit 120 preferably includes a pre-processing function for the transfer learning data. For example, when the sizes of images of the pre-training data and the transfer learning data are different from each other, the transfer learning data input unit 120 may change the size of the image of the transfer learning data to the same image size as that of the pre-training data.

The user requirement input unit 130 receives a user requirement. In an embodiment, the user requirement input unit 130 may input a user requirement received through an input device such as a keyboard, mouse, or touch screen provided in a computer or mobile terminal used by the user.

Here, the user requirement may be a requirement for the pre-trained model, such as the size of the pre-trained model (the file size or the number of parameters) or the amount of calculation (FLOPs, Multi-Adds) of the pre-trained model. For example, when the user prefers a small deep neural network model, the user requirement input unit 130 may input an upper limit of the number of parameters of the pre-trained model. Alternatively, the user requirement input unit 130 may input an upper limit of the amount of calculation (FLOPs, Multi-Adds) of the pre-trained model.

In addition, user's preference for the pre-training data may be included. For example, when the transfer learning data is data for classifying flowers, a user requirement may be input such that a pre-trained model learned using the pre-training data related to plants is selected.

The pre-trained model selecting unit 140 selects a pre-trained model corresponding to the transfer learning data input from the transfer learning data input unit 120 from among a plurality of pre-trained models stored in the pre-trained model storage unit 110. In an embodiment, \textcircled{1} the pre-trained model selecting unit 140 may select a pre-trained model based on the user requirement input from the user requirement input unit 130, and \textcircled{2} select one or more pre-trained models through a pre-trained model selecting process using transfer learning data input from the transfer learning data input unit 120. However, as various embodiments of the present invention, method \textcircled{1} and method \textcircled{2} above may be used alone or together to select a pre-trained model. For example, if the number of pre-trained models is not large or there is no user requirement, method \textcircled{1} may not be used. In addition, even when method \textcircled{1} and method \textcircled{2} are used together, method \textcircled{1} may be performed first, followed by method \textcircled{2}, or vice versa.

In an embodiment, an example in which the pre-trained model selecting unit 140 of the transfer learning system 100 for a deep neural network according to an embodiment of the present invention \textcircled{1} first selects a pre-trained model based on a user requirement, and then \textcircled{2} selects a pre-trained model using transfer learning data, among the pre-trained models selected based on the user requirement will be described.

A process in which the pre-trained model selecting unit 140 selects a pre-trained model based on a user requirement may be performed through a typical constraint search process. For example, when the user requirement input unit 130 limits a size of the pre-trained model to 1 MB, the pre-trained model selecting unit 140 selects a pre-trained model of 1 MB or less. As another example, when the upper limit of the calculation amount is input as 100 M Flops in the user requirement input unit 130, the pre-trained model selecting unit 140 selects a pre-trained model of 100 M Flops or less. In a similar manner, the user requirement input unit 130 specifies a condition for the pre-training data used in the pre-trained model, and the pre-trained model selecting unit 140 selects the pre-trained model. For example, when the transfer learning data is data for classifying flowers, the pre-trained model selecting unit 140 selects a pre-trained model learned by using pre-training data related to plants.

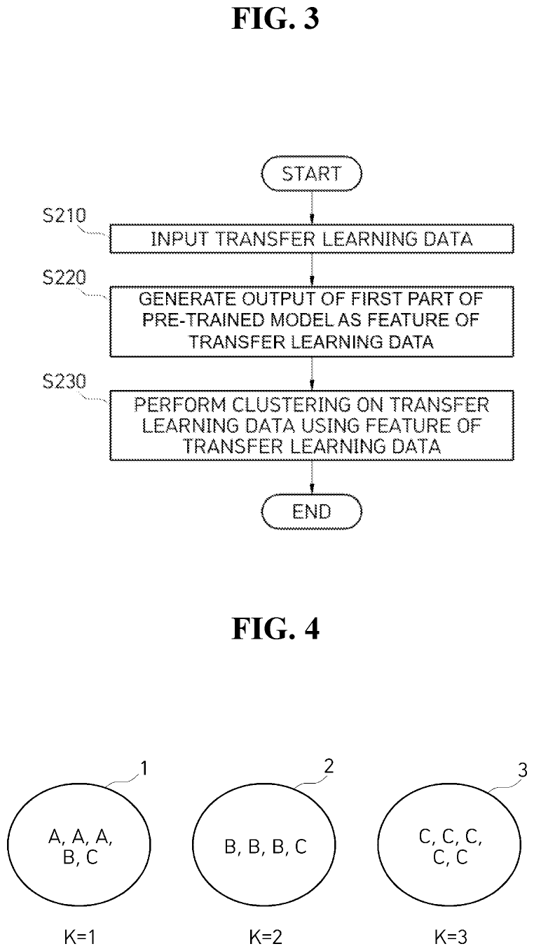

The process in which the pre-trained model selecting unit 140 \textcircled{2} selects a pre-trained model using transfer learning data will be described in detail with reference to FIG. 3 below.

FIG. 3 is a diagram illustrating a process of selecting a pre-trained model in the pre-trained model selecting unit of the transfer learning system for a deep neural network according to an embodiment of the present invention.

As previously described with reference to FIG. 2, the CNN 10 includes the first part 11 including convolutions and pooling operations and the second part 12 including a fully connected layer or a dense layer. Referring to FIG. 3, when transfer learning data is input through the transfer learning data input unit 120 (S210), the pre-trained model selecting unit 140 may regard an output of the first part or the second part of the plurality of stored pre-trained models as a feature of the transfer learning data or derive the feature of the transfer learning data using the output of the first part 11 or the second part 12. At this time, when the pre-trained model selecting unit 140 uses the user requirement, the output of the first or second part of the pre-trained model(s) corresponding to the user requirement is used as a feature of the transfer learning data (S220).

As described above, the first or second part of the pre-trained model using the deep neural network refines by stages to extract the main information of the input data, so the output of the first or the second part of the pre-trained model may be used as a feature of the transfer learning data.

In another embodiment, the pre-trained model selecting unit 140 may use the output of an intermediate layer between the input layer and a last layer of the first part as a feature of the transfer learning data, but preferably use an output of the last layer of the first part as a feature of the transfer learning data.

In another embodiment, the pre-trained model selecting unit 140 may use the output of the intermediate layer between the input layer and the last layer of the second part as a feature of the transfer learning data, but preferably use an output of the last layer of the second part as a feature of the transfer learning data.

After generating the output of the first part or the second part of the pre-trained model as a feature of the transfer learning data (S220), the pre-trained model selecting unit 140 performs clustering on the transfer learning data using the feature of the transfer learning data (S230). As examples of algorithms that may be used as a clustering module in the pre-trained model selecting unit 140, algorithms such as K-means, Fuzzy K-Means, K-Medoids, and hierarchical clustering, density-based clustering (DBScan), hierarchical density-based clustering (HDBScan), etc. may be used, and the clustering algorithm that may be used by the pre-trained model selecting unit 140 of the transfer learning system 100 for a deep neural network according to an embodiment of the present invention is not limited to the aforementioned clustering algorithm.

Most clustering algorithms require the user to specify the number of clusters in advance. The pre-trained model selecting unit 140 according to an embodiment of the present invention sets the number of clusters equal to the number of classes of the transfer learning data so that one class constituting the transfer learning data may correspond to one cluster.

As another embodiment, since a specific class may include two or more prominent detailed classes, the pre-trained model selecting unit 140 may set a total number of clusters to be larger than the number of classes of transfer learning data.

The pre-trained model selecting unit 140 performs clustering evaluation after performing clustering. In an embodiment, the pre-trained model selecting unit 140 may perform performance evaluation on the result of performing clustering and select pre-trained models in the order of the highest performance evaluation scores. There are several methods for the pre-trained model selecting unit 140 to calculate a clustering performance evaluation scale, and an example of the method of evaluating clustering performance will be described using the example of FIG. 4.

FIG. 4 is an example illustrating a process of evaluating clustering in the pre-trained model selecting unit of the transfer learning system for a deep neural network according to an embodiment of the present invention.

As shown in FIG. 4, it is assumed that there are three classes of transfer learning data: A, B, and C. Therefore, it is assumed that clustering is performed using the feature of transfer learning data by setting the number of clusters to 3 as well. It is assumed that, through the clustering process described above, three pieces of data of class A, one piece of data of class B, and one piece of data of class C are allocated to a first cluster 1 (K=1). It is assumed that 0 data of class A, three pieces of data of class B, and one piece of data of class C are allocated to a second cluster 2 (K=2). It is assumed 0 data of class A, 0 data of class B, and six pieces of data of class C are allocated to a third cluster 3 (K=3).

As a first evaluation method, purity is described. The pre-trained model selecting unit 140 may calculate a performance evaluation score based on the purity derived through Equation 1 below with respect to the result of performing clustering.

$$purity = \frac{1}{N} {\sum }_{k} {max}_{j} {N}_{k , j} \qquad [ Equation 1 ]$$

Here, N is the total number of pieces of data, and N_{k,j} is the number of j-th classes belonging to a k-th cluster. In the example of FIG. 4, the purity is calculated as in Equation 2 below.

$$purity = \frac{1}{15} ( 3 + 3 + 6 ) \qquad [ Equation 2 ]$$

Another evaluation method is normalized mutual information (NMI). The pre-trained model selecting unit 140 may calculate the performance evaluation score based on an NMI derived through Equation 3 below with respect to the result of performing clustering.

$$NMI ( Y , K ) = \frac{2 \times I ( Y ; K )}{[ H ( Y ) + H ( K ) ]} \qquad [ Equation 3 ]$$

Here, Y is a random variable for a class label of the transfer learning data, K is a random variable for a cluster label, HO is entropy, and I(Y;K) is mutual information between Y and K.

A calculation process will be described with reference to FIG. 4 as an example. The distribution of Y is calculated as in Equation 4 below.

$$P ( Y = A ) = \frac{3}{15} , P ( Y = B ) = \frac{4}{15} , P ( Y = C ) = \frac{8}{15} . \qquad [ Equation 4 ]$$

Based on this 4, H(Y) is calculated as in Equation 5 below.

$$H ( Y ) = - {\sum }_{y ∈ \{ A , B , C \}} P ( Y = y ) log P ( Y = y ) = - [ \frac{3}{15} log ( \frac{3}{15} ) + \frac{4}{15} log ( \frac{4}{15} ) + \frac{8}{15} log ( \frac{8}{15} ) ] \qquad [ Equation 5 ]$$

The distribution of K is calculated as in Equation 6 below.

$$P ( K = 1 ) = \frac{5}{15} , P ( K = 2 ) = \frac{4}{15} , P ( K = 3 ) = \frac{6}{15} \qquad [ Equation 6 ]$$

Based on this, H(K) is calculated as in Equation 7 below.

$$H ( Y ) = - {\sum }_{y ∈ \{ 1 , 2 , 3 \}} P ( K = k ) log P ( K = k ) = - [ \frac{5}{15} log ( \frac{5}{15} ) - \frac{4}{15} log ( \frac{4}{15} ) - \frac{6}{15} log ( \frac{6}{15} ) ] \qquad [ Equation 7 ]$$

I(Y;K) and H(Y|K) are defined as in Equations 8 and 9, respectively.

I(Y;K)=H(Y) [Equation 8]

$$H ( Y \vert K ) = {\sum }_{k ∈ \{ 1 , 2 , 3 \}} H ( Y \vert K = k ) \qquad [ Equation 9 ]$$

In the above equation, each term of H(Y|K=k) is calculated as in Equations 10 to 12 below.

$$H ( Y \vert K = 1 ) = - P ( K = 1 ) {\sum }_{y ∈ \{ A , B , C \}} P ( Y = y \vert K = 1 ) log P ( Y = y \vert K = 1 ) = - \frac{5}{15} \times [ \frac{3}{5} log ( \frac{3}{5} ) + \frac{1}{5} log ( \frac{1}{5} ) + \frac{1}{5} log ( \frac{1}{5} ) ] \qquad [ Equation 10 ]$$

$$H ( Y \vert K = 2 ) = - P ( K = 2 ) {\sum }_{y ∈ \{ A , B , C \}} P ( Y = y \vert K = 2 ) log P ( Y = y \vert K = 2 ) = - \frac{4}{15} \times [ 0 + \frac{3}{4} log ( \frac{3}{4} ) + \frac{1}{4} log ( \frac{1}{4} ) ] \qquad [ Equation 11 ]$$

$$H ( Y \vert K = 3 ) = - P ( K = 3 ) {\sum }_{y ∈ \{ A , B , C \}} P ( Y = y \vert K = 3 ) log P ( Y = y \vert K = 3 ) = - \frac{6}{15} \times [ 0 + 0 + \frac{6}{6} log ( \frac{6}{6} ) ] \qquad [ Equation 12 ]$$

As the value of the clustering performance evaluation scale derived through the above process increases, it means that each cluster includes only a single type (class) of data. If one type (class) of data is allocated to each cluster, the value becomes the maximum.

The reason for selecting a pre-training model through clustering is as follows. This is because, when the transfer learning data is very well clustered using the feature extracted through the pre-trained model, the possibility that the pre-trained model may distinguish the classes of the transfer learning data well is high.

When M pre-trained models are selected, the pre-trained model selecting unit 140 may calculate M evaluation scores by repeating the above process for each pre-trained model, and select P (P≤M) pre-trained models in the order, starting from the higher score.

The transfer learning unit 150 generates a plurality of transfer learning models by performing transfer learning using the pre-trained model selected by the pre-trained model selecting unit 140 and the transfer learning data input from the transfer learning data input unit 120. The transfer learning unit 150 generates P transfer learning models by performing transfer learning using the P selected pre-trained models and the transfer learning data. The transfer learning of the transfer learning unit 150 uses a known transfer learning method and is not limited to a specific learning method.

In an embodiment, it is preferable to use some of the transfer learning data as validation data. The transfer learning unit 150 evaluates the classification performance of the P transfer learning models by using the verification data. Classification performance evaluation may be calculated by Top-1 accuracy or area under the receiver operating characteristic curve (ROC-AUC) score.

The transfer learning model output unit 160 may calculate classification performance accuracy for the plurality of transfer learning models generated by the transfer learning unit 150, and select and output one or more transfer learning models in the order, starting from a transfer learning mode having the highest classification performance accuracy, among the plurality of transfer learning models generated by the transfer learning unit 150. In an embodiment, the transfer learning model output unit 160 may select T (T≤P) transfer learning models from among the P transfer learning models generated by the transfer learning unit 150. In this case, the transfer learning models may be selected based on classification performance calculated by the transfer learning unit 150 as a selection criterion.

When two or more transfer learning models are selected, the transfer learning model output unit 160 may configure a final transfer learning model in an ensemble form. In an embodiment, the transfer learning model output unit 160 may generate and output a final transfer learning model y(x) by configuring an ensemble by Equation 13 below with respect to one or more selected transfer learning models.

$$y ( x ) = {\sum }_{t = 1}^{T} {w}_{t} {y}_{t} ( x ) \qquad [ Equation 13 ]$$

Here, y(x) is the final transfer learning model, yₜ(x) is an arbitrary transfer learning model among T transfer learning models, and wₜ is an ensemble weight. Briefly, the same weight may be set for all transfer learning models by wt=1/T. Preferably, it is set in proportion to the classification performance of the transfer learning model. For example, if T=3 and the classification accuracy of each transfer learning model is 95%, 90%, or 85%, the ensemble weight may be set as shown in Equation 14 below.

$${w}_{1} = \frac{95}{95 + 90 + 85} , {w}_{2} = \frac{90}{95 + 90 + 85} , {w}_{3} = \frac{85}{95 + 90 + 85} . \qquad [ Equation 14 ]$$

In another embodiment, the transfer learning model output unit 160 may sequentially configure an ensemble using the following method. In an embodiment, the transfer learning model output unit 160 may first select a first transfer learning model having the highest classification performance accuracy and select a second transfer learning model having the greatest accuracy improvement when configuring an ensemble with the first transfer learning model, to configure an ensemble.

In addition, by expanding this, the transfer learning model output unit 160 may select, as a third ensemble member, a transfer learning model having the greatest accuracy improvement when added to the ensemble including the first transfer learning model and the second transfer learning model, to configure an ensemble including three transfer learning models.

In a similar manner, the number of members of the ensemble may be increased. If a maximum number of ensemble members is previously set, the above process may be repeated as many as the number to add ensemble members to configure the ensemble.

As another embodiment, the ensemble may be configured by setting the required accuracy in advance and sequentially adding the transfer learning model in the aforementioned manner until the set accuracy is satisfied.

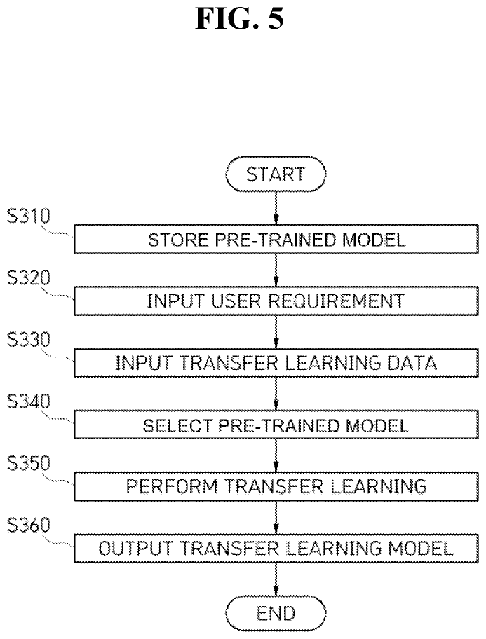

FIG. 5 is a flowchart illustrating a transfer learning method for a deep neural network according to an embodiment of the present invention.

Referring to FIG. 5, in a pre-trained model storing step (S310), a plurality of pre-trained models that are deep neural network models learned using a plurality of pre-training datasets are stored.

In addition, in a user requirement input step (S320), a user requirement is input, and in a transfer learning data input step (S330), transfer learning data is input.

After inputting the user requirement and transfer learning data, a pre-trained model corresponding to the input user requirement or the input transfer learning data is selected in the pre-trained model selecting step (S340).

Thereafter, in a transfer learning step S350, transfer learning is performed using the selected pre-trained model and transfer learning data to generate a plurality of transfer learning models.

In the learning model output step (S360), classification performance accuracy is calculated for the plurality of generated transfer learning models, and one or more transfer learning models are selected in the order of the highest classification performance accuracy from among the plurality of generated transfer learning models.

The transfer learning method for a deep neural network according to an embodiment of the present invention may be implemented by each component of the transfer learning system for a deep neural network described above, and since the transfer learning method for a deep neural network according to an embodiment of the present invention performs transfer learning similarly to the transfer learning system for a deep neural network described above, a detailed description of the transfer learning method for a deep neural network according to an embodiment of the present invention is omitted to prevent a redundant description.

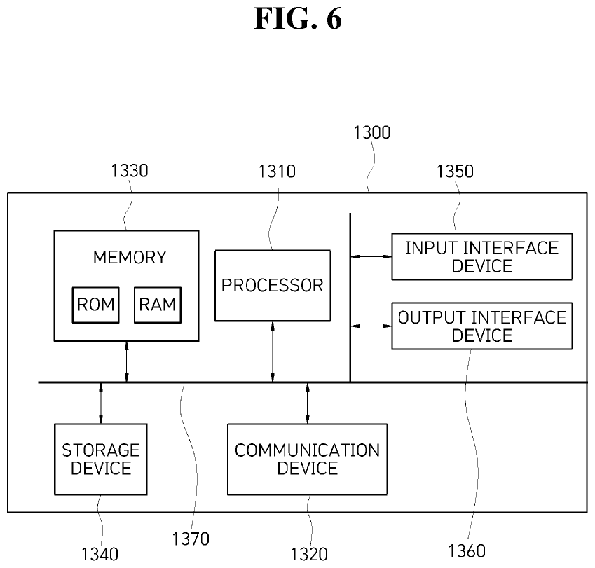

FIG. 6 is a block diagram illustrating a computer system for implementing a transfer learning method for a deep neural network according to an embodiment of the present invention.

Referring to FIG. 6, a computer system 1300 according to an embodiment of the present invention may include at least one of a processor 1310, a memory 1330, an input interface device 1350, an output interface device 1360, and a storage device 1340 communicating through a bus 1370 to implement a transfer learning method for a deep neural network.

The computer system 1300 may also include a communication device 1320 coupled to a network. The processor 1310 may be a central processing unit (CPU) or a semiconductor device that executes instructions stored in the memory 1330 or the storage device 1340.

The memory 1330 and the storage device 1340 may include various types of volatile or nonvolatile storage mediums. For example, the memory may include read only memory (ROM) and random access memory (RAM).

In the present embodiment, the memory may be located inside or outside the processor, and the memory may be connected to the processor through various known means. The memory is various types of volatile or nonvolatile storage mediums, and for example, the memory may include a read-only memory (ROM) or a random access memory (RAM).

In addition, the transfer learning method for a deep neural network according to an embodiment of the present invention may be implemented as a program and may be stored in a computer-readable form in a recording medium such as a CD-ROM, RAM, ROM, a floppy disk, a hard disk, a magneto-optical disk, a secure digital (SD) card, a micro SD card, and a universal serial bus (USB) memory.

The transfer learning method for a deep neural network according to an embodiment of the present invention may be implemented in the form of a web-based program or in the form of an application installed in a mobile terminal. In addition, the program in which the transfer learning method for a deep neural network according to an embodiment of the present invention is implemented may be installed in the transfer learning system for a deep neural network according to an embodiment of the present invention.

It will be apparent to those skilled in the art that various modifications and variations may be made in the present invention without departing from the spirit or scope of the inventions. Thus, it is intended that the present invention covers the modifications and variations of this invention provided they come within the scope of the appended claims and their equivalents.

1. A transfer learning system for a deep neural network, the transfer learning system comprising:
a pre-trained model storage unit configured to store a plurality of pre-trained models that are deep neural network models learned using one or more pre-training datasets;
a transfer learning data input unit configured to receive transfer learning data;
a pre-trained model selecting unit configured to select a pre-trained model corresponding to the transfer learning data from among the plurality of stored pre-trained models; and
a transfer learning unit configured to generate one or more transfer learning models by performing transfer learning using the selected pre-trained model and the transfer learning data.

2. The transfer learning system of claim 1, wherein the pre-trained model selecting unit derives a feature of the transfer learning data from an output of a first part or a second part of the plurality of stored pre-trained models and selects a pre-trained model based on clustering for the transfer leaning data using the feature of the transfer learning data.

3. The transfer learning system of claim 1, further comprising:
a user requirement input unit for inputting a user requirement,
wherein the pre-trained model selecting unit selects a pre-trained model corresponding to the input user requirement or the input transfer learning data.

4. The transfer learning system of claim 3, wherein the pre-trained model selecting unit derives feature of the transfer learning data based on an output of a first part or a second part of the pre-trained model corresponding to the user requirement and selects a pre-trained model based on clustering for the transfer leaning data using the feature of the transfer learning data.

5. The transfer learning system of claim 2,
wherein the pre-trained model selecting unit performs performance evaluation on a result of performing clustering and selects the pre-trained model in the order of the highest performance evaluation score.

6. The transfer learning system of claim 5, wherein
the pre-trained model selecting unit calculates the performance evaluation score by purity derived through the following equation for the result of performing the clustering:
$$purity = \frac{1}{N} {\sum }_{k} {max}_{j} {N}_{k , j} \qquad [ Equation ]$$
wherein N is a total number of data, N_{k,j} is the number of j-th classes in a k-th cluster.

7. The transfer learning system of claim 5, wherein
the pre-trained model selecting unit calculates the performance evaluation score based on normalized mutual information (NMI) derived through the following equation for the result of performing the clustering:
$$NMI ( Y , K ) = \frac{2 \times I ( Y ; K )}{[ H ( Y ) + H ( K ) ]} \qquad [ Equation ]$$
wherein Y is a random variable for a class label of the transfer learning data, K is a random variable for a cluster label, H( ) is entropy, and I(Y;K) is mutual information between Y and K.

8. The transfer learning system of claim 1, further comprising:
a transfer learning model output unit configured to calculate classification performance accuracy for the plurality of generated transfer learning models and select and output one or more transfer learning models in the order of the highest classification performance accuracy.

9. The transfer learning system of claim 1, wherein
the transfer learning model output unit generates and outputs a final transfer learning model y(x) by configuring an ensemble by the following equation for the one or more selected transfer learning models:
$$y ( x ) = {\sum }_{t = 1}^{T} {w}_{t} {y}_{t} ( x ) \qquad [ Equation ]$$
wherein y(x) is a final transfer learning model, yt(x) is any transfer learning model among T, and wₜ is an ensemble weight.

10. The transfer learning system of claim 9, wherein the transfer learning model output unit first selects a first transfer learning model having the highest classification performance accuracy, and selects a second transfer learning model having the greatest accuracy improvement when configuring an ensemble with the first transfer learning model, to configure the ensemble.

11. The transfer learning system of claim 10, wherein the transfer learning model output unit configures the ensemble by adding a transfer learning mode having the highest accuracy improvement, when added to a previously configured ensemble, as an ensemble member.

12. A transfer learning method for a deep neural network, the transfer learning method comprising:
a pre-trained model storing step of storing a plurality of pre-trained models that are deep neural network models learned using a plurality of pre-training datasets;
a transfer learning data input step of inputting transfer learning data;
a pre-trained model selecting step of selecting a pre-trained model corresponding to the input transfer learning data from among the plurality of stored pre-trained models; and
a transfer learning step of generating a plurality of transfer learning models by performing transfer learning using the selected pre-trained model and the transfer learning data.

13. The transfer learning method of claim 12, wherein
the pre-trained model selecting step includes:
generating an output of a first part or a second part of the plurality of stored pre-trained models as a feature of the transfer learning data; and
selecting a pre-trained model by performing clustering on the transfer learning data by using the feature of the transfer learning data.

14. The transfer learning method of claim 12, further comprising:
a user requirement input step of inputting a user requirement,
wherein the pre-trained model selecting step includes selecting a pre-trained model corresponding to the input user requirement or the input transfer learning data.

15. The transfer learning method of claim 12, wherein
the pre-trained model selecting step includes:
generating an output of a first part or a second part of the pre-trained model corresponding to the user requirement as a feature of the transfer learning data; and
selecting a pre-trained model by performing clustering on the transfer learning data by using the feature of the transfer learning data.

16. The transfer learning method of claim 12, further comprising:
a transfer learning model output step of calculating classification performance accuracy for the plurality of generated transfer learning models, and selecting and outputting one or more transfer learning models in the order of the highest classification performance accuracy among the plurality of generated transfer learning models.

17. A transfer learning method for a deep neural network, the transfer learning method comprising:
a pre-trained model selecting step of selecting a pre-trained model corresponding to transfer learning data from among a plurality of stored pre-trained models;
a transfer learning step of generating a plurality of transfer learning models by performing transfer learning using the selected pre-trained model and the transfer learning data; and
a step of configuring an ensemble by selecting at least some of the plurality of transfer learning models.

18. The transfer learning method of claim 17, wherein
the step of configuring the ensemble includes:
first selecting a first transfer learning model having a highest classification performance accuracy is, and
selecting a second transfer learning model having the greatest accuracy improvement when configuring an ensemble with the first transfer learning model, to configure the ensemble.

19. The transfer learning method of claim 18, wherein
the step of configuring the ensemble includes configuring the ensemble by adding a transfer learning mode having the highest accuracy improvement, when added to a previously configured ensemble, as an ensemble member.

20. The transfer learning method of claim 17, wherein the step of configuring the ensemble includes configuring an ensemble by adding a transfer learning model having the highest accuracy among the plurality of transfer learning models and a transfer learning model that contributes the most to improvement of accuracy of the transfer learning model; and sequentially adding a transfer learning model that contributes the most to the improvement of the accuracy of the pre-configured ensemble to the ensemble until a preset accuracy is satisfied.
